(19) United States
(12) Patent Application Publication
(10) Pub. No.: US 2013/0213524 A1
(43) Pub. Date: Aug. 22, 2013

(54) TRANSPORTABLE APPARATUS FOR RE-CONDITIONING WINE BARRELS USING A TURNSTILE

(71) Applicant: Breck Waterman, Hawthorn (AU)

(72) Inventor: Breck Waterman, Hawthorn (AU)

(73) Assignee: DIVERSE BARREL SOLUTIONS PTY LTD, Keswick (AU)

(21) Appl. No.: 13/640,631

(22) PCT Filed: Apr. 13, 2011
(86) PCT No.: PCT/AU2011/000418

§ 371 Date: Dec. 20, 2012

(30) Foreign Application Priority Data
Apr. 13, 2010 (AU) 2010901558

(51) Int. Cl. B27H 5/00; B23C 1/20

(52) U.S. Cl. CPC B27H 5/00; B23C 1/20
USPC 147/1; 409/143; 408/131

(57) ABSTRACT

An apparatus for reconditioning barrels, said apparatus including a means to lockingly engage a barrel in a first position, a moving means to move the locked barrel into a second position, a scanner to scan the internal surface of the locked barrel when in the second position and collect scanned data, the moving means then moving the locked barrel to a third position and a means to cut a selected depth of the internal surface of the locked barrel when in the third position according to the collected data. The moving means is a turnstile with three section enabling three barrels to be in the apparatus at any one time, so that whilst one barrel is being scanned, one is being cut and a third is being unloaded/loaded into the apparatus.

### BACKGROUND OF THE INVENTION

Wine is traditionally aged in oak barrels. The oak is integral to aging and imparting certain flavours to the wines. Wine fermenting and aging in wood barrels extracts flavour components from the wood and leaves a residue of precipitated materials such as tartrates, fining agents or yeast. Further, wine processing often leaves undesirable bacterial infections in the barrels for which there is no current remedy.

Wine colour typically penetrates into a solid barrel stave approximately 2 mm with alcohol penetrating even deeper to some 5 to 6 mm. Over time (typically after two to three uses), all components which can be extracted from the oak will be, and the residue left in the wood can begin to sour or block the membrane exchangeability of the wood. The barrel is then considered exhausted and is viewed either as a liability because of contamination, or as neutral storage for additional vintages.

Due to the high cost of new barrels there have been many attempts to be able to recondition barrels so that they can be used again as barrels imparting flavour and not just as neutral storage. Current reconditioning methods involve either transporting used barrels from vineyards to cooperage plants or doing it on site where the internal surfaces of the barrels are shaved and then maybe toasted for re-use. Current methods of barrel shaving vary from simple hand held cutting routers and wire brushes, to more complex apparatus such as motorised cutting apparatus. All of these techniques take time, and where there are large numbers of barrels to recondition it becomes uneconomical to do so.

It is time consuming and expensive to have used barrels transported from a vineyard to a cooperage plant for reconditioning, and then to have them transported back to the vineyard for use. This problem is exacerbated when a cooperage is located long distances away from a vineyard, which is the case more often than not. The present inventor has realised a need in the wine industry for a transportable apparatus and system of reconditioning barrels which would provide a vineyard owner, for example, with the ability to have used barrels reconditioned within a day or two in the local area, as opposed to weeks or longer in the case of barrels transported to and from a cooperage facility.

Whilst there are systems that can recondition a barrel even on site, these systems treat one barrel at a time and thus take a considerable amount of time to treat just one barrel.

### OBJECT OF THE INVENTION

It is therefore an object of the present invention to provide for a system that can recondition barrels taking less time then hitherto know or to at least provide the public with a useful alternative.

It is a further object of the present invention to provide a system that can recondition barrels in a continuous manner whereby the time to recondition barrels is minimised.

### SUMMARY OF THE INVENTION

In a broad aspect of the invention there is proposed an apparatus for reconditioning barrels, said apparatus including:

a means to lockingly engage a barrel in a first position;

a moving means to move the locked barrel into a second position;

a means to scan the internal surface of the locked barrel when in the second position and collect data;

the moving means adapted to move the locked barrel to a third position; and

a means to cut a selected depth of the internal surface of the locked barrel when in the third position.

In preference the selected depth cut is constant across the inner surface by using the collected data.

In preference the moving means is a turnstile having three sections adapted to rotate around a central axis, each of the sections including the means to lock the barrel.

In preference the scanning means is adapted to vertically traverse the inside surface of the barrel to thereby scan a portion thereof with each pass.

In preference the cutting means is adapted to vertically traverse the inside surface of the barrel to thereby shave a portion thereof with each pass.

In preference the cutting means is adapted to traverse the inside surface of the barrel in a continuous helical type arrangement.

In preference said apparatus includes a conveyor belt positioned below the barrel being shaved to remove shave wood from the apparatus.

In a further form of the invention there is proposed a method of reconditioning a barrel including the steps of:

loading and securing the barrel into a turnstile in a first position;

rotating the loaded barrel to a second position;

scanning the inner surface of the barrel at discrete positions and forming a database of said surface;

rotating the barrel to a third position;

routing the inner surface of the barrel according to the scanned inner surface to produce a constant depth of routing; and

rotating the barrel to the first position and unloading the barrel.

In preference the turnstile includes three sections, a barrel able to be supported in each section so that barrels are being simultaneously loaded, scanned, routed and unloaded.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings:

FIG. 1 is a schematic perspective view illustrating how the proposed apparatus embodying the invention may look when housed in a transportable building;

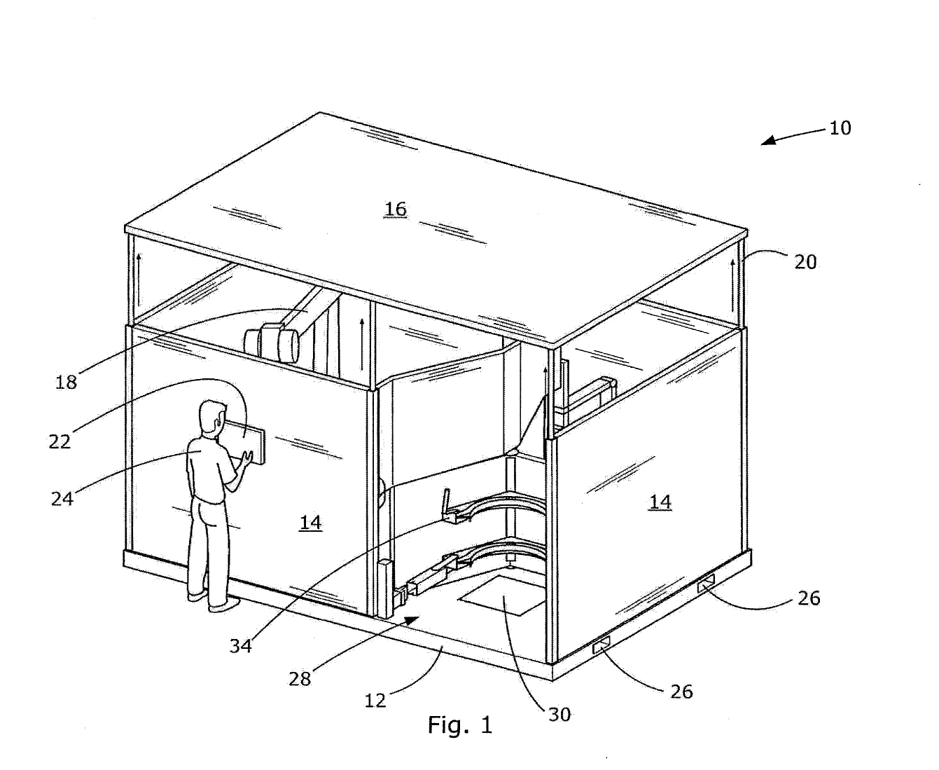

FIG. 2 is the same as for FIG. 1 but with the outside walls removed;

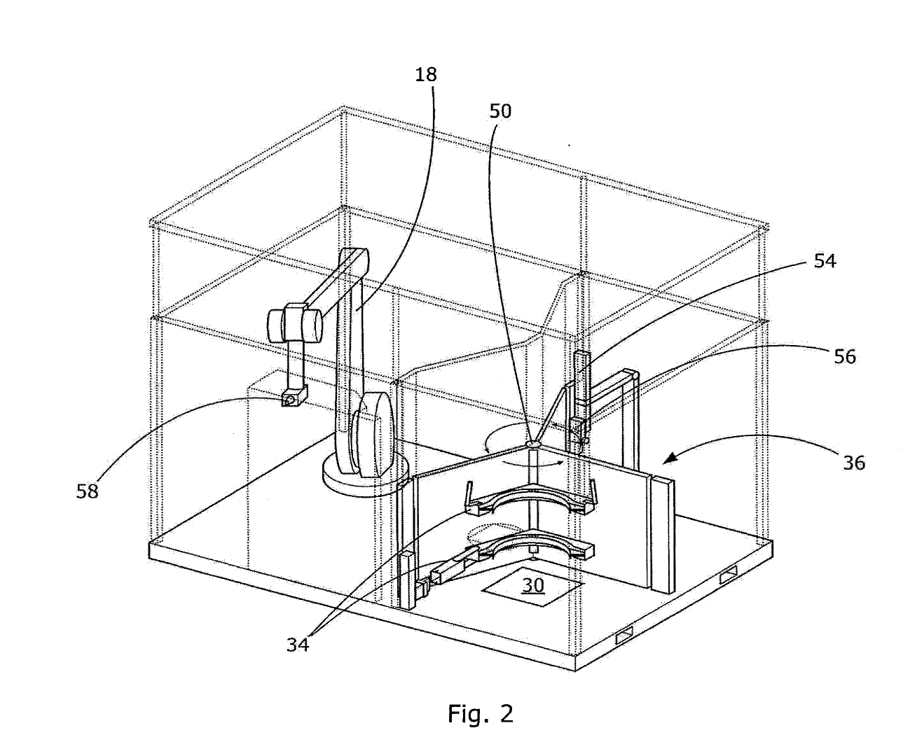

FIG. 3 illustrates the first step in the invention when a barrel is loaded;

FIG. 4 illustrates the second step in the invention when the inside surface of the barrel is scanned;

FIG. 5 illustrates the third step of the invention when the inside surface of the barrel is routed;

FIG. 6 illustrates interior curtains disposed within the building so as to isolate the three operating chambers;

FIG. 7 is a rear perspective view of the building illustrating the disposal of the wood shavings;

FIG. 8 is a top view of the present invention;

FIG. 9 illustrates the present invention when three barrels are located in the building as it is envisaged that the apparatus would be operated; and

FIG. 10 is an alternate construction of the movement of the barrels within the building.

### LIST OF COMPONENTS

10 building
12 chassis
14 supporting walls
16 roof
18 robotic arm
20 sliding corner posts
22 control panel
24 user
26 forklift channels
28 opening
30 30
32 barrel
34 clamps
36 turnstile
38 first section
40 second section
42 third section
44 wall
46 wall
48 wall
50 central pivot
52 scanning assembly
54 arm
56 scanner
58 router
60 curtains
62 conveyor belt
64 shave wood
66 choke
68 conveyor belt
70 clamps
72 scanning assembly
74 clamps

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts. Dimensions of certain of the parts shown in the drawings may have been modified and/or exaggerated for the purposes of clarity or illustration.

The general purpose of the invention is to provide an apparatus that can be taken to say a location, such as a winery, where a number of barrels can be reconditioned after which the apparatus is to be moved to a different location. However that is not to say that the present apparatus may not be permanently installed in a winery that has lots of barrels to shave over the course of the whole year.

Referring now to the Figures there is illustrated a building 10 including a chassis 12 supporting walls 14 and roof 16. Given that the apparatus may want to be transported, one wants to minimise the physical volume of the building. Typically the robotic arm 18 can be moved to a sleep position occupying a minimum height so that the height of the building need only be as high as the robotic arm in the sleep position. To be used however the robotic arm has to extend vertically. For that reason the roof 16 can be adapted to be raised. This may be achieved by supporting the roof on sliding corner posts 20. It is not however the intention of the present specification to provide a solution for raising a roof since this will be something that is standard engineering practice. Suffice to say that the roof can be adapted to be mechanically or hydraulically operable and locked in position.

The building 10 includes a control panel 22 that will enable user 24 to operate the apparatus. The building may further include forklift channels 26 to enable it to be moved by a forklift around the place, onto flat bed trucks or even shipping containers.

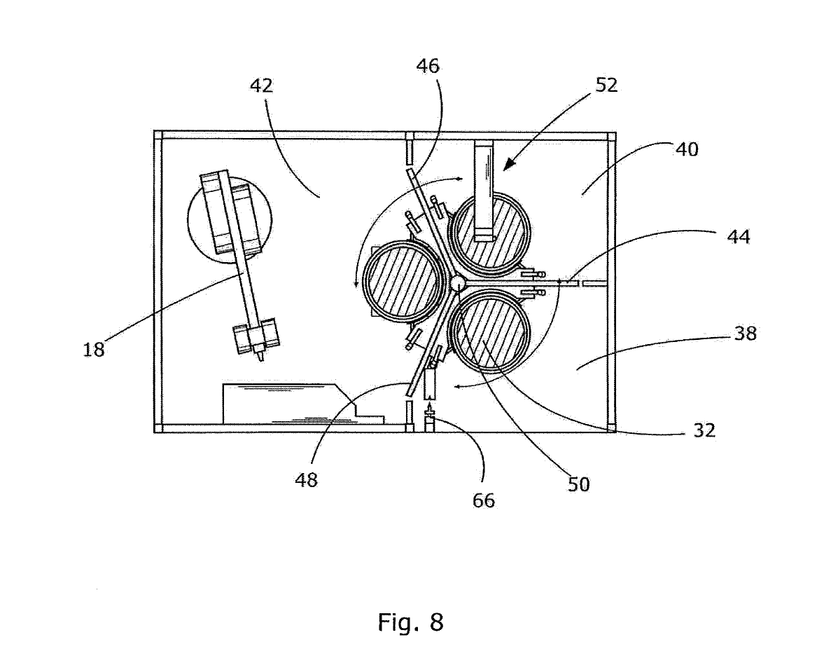

Although not necessary a door (not shown) may be provided at the point where one wants to load a barrel. Such a door may be removable so as to leave an opening 28 into a first chamber having a vertically movable floor 30. A barrel 32 is placed on floor 30 which is then raised until the barrel is in an appropriate vertical position to be locked by two clamps 34 to a turnstile 36 divided into three sections 38, 40 and 42 by walls 44, 46 and 48 (see FIG. 8). When the barrel has been locked into a fixed position to the turnstile 36 the floor 30 is lowered leaving the barrel suspended.

Turnstile 36 is adapted to rotate around central pivot 50 in an anti-clockwise direction, although it may equally well rotate in the other direction that depending on the configuration of the apparatus.

The clamps 34 are flexible hoops that are pneumatically driven to change their radius of curvature. Thus before the barrel is loaded the hoops provide a wide throat that is then reduced to clamp the barrel into place. Although not shown additional locking means are generally provided across the front of the barrel, such as tie-downs, to ensure the barrel remains locked in place. Of course, the moving of the hoops may be achieved by other means and it is not intended to limit the invention to a pneumatic operation.

Turnstile 36 thus rotates through three sections 38, 40 and 42. In section 38 the barrel is loaded and clamped to the turnstile. Once loaded the turnstile rotates through 120 degrees to section 40. Located in section 40 is a scanning assembly 52 including an arm 54 adapted to vertically move scanner 56 within the barrel 32 thereby scanning the inside surface to provide a three-dimensional map of the internal surface of the barrel 32.

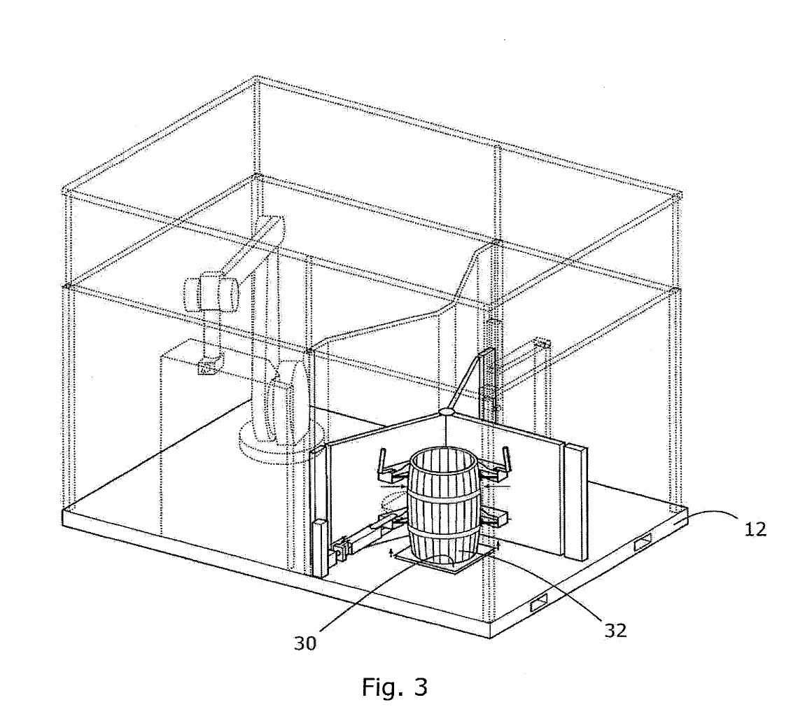

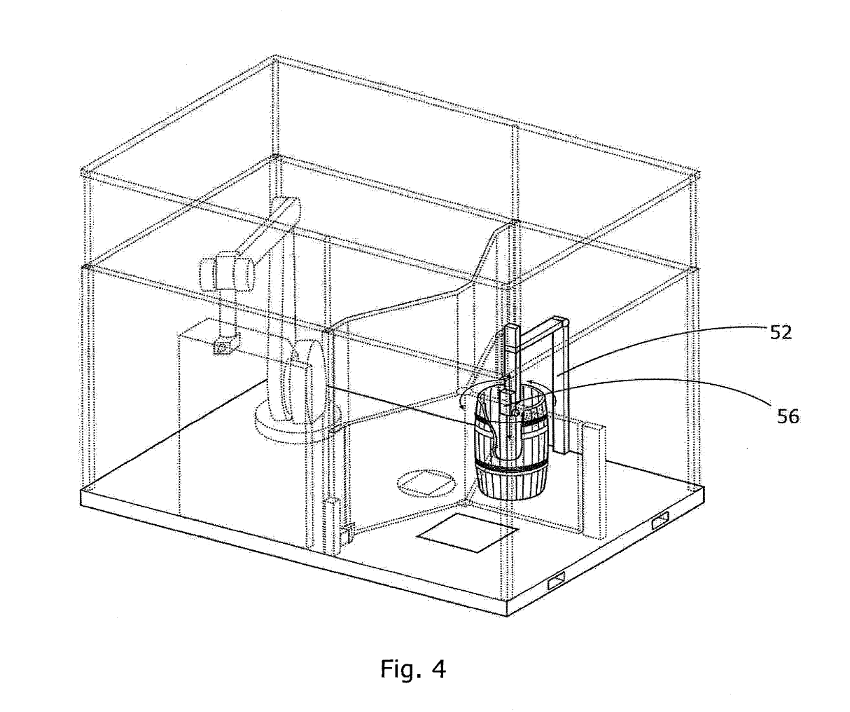

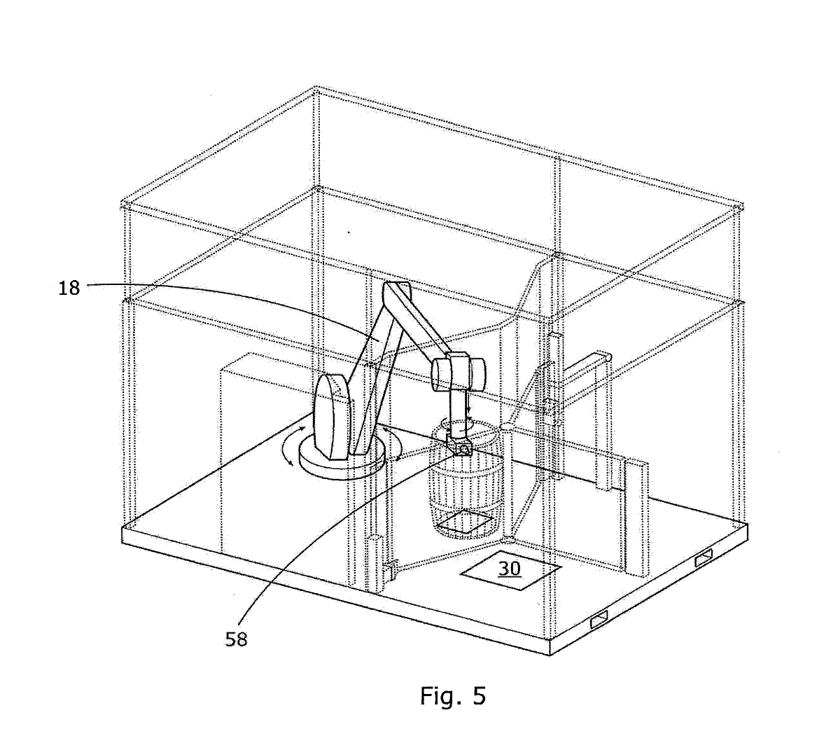

The scanned barrel is then rotated to section 42. Located in section 42 is robotic arm 18 providing support to router 58. The robotic arm is pre-programmed to rout or cut a pre-determined depth of the inside surface of the barrel, something it can do given that the internal surface has been mapped. Whilst typically a constant amount of wood is cut or routed, there is no reason why the internal surface may not be cut at different depths across the internal surface of the barrel. The operation of the three sections is conveniently shown in FIGS. 3-5.

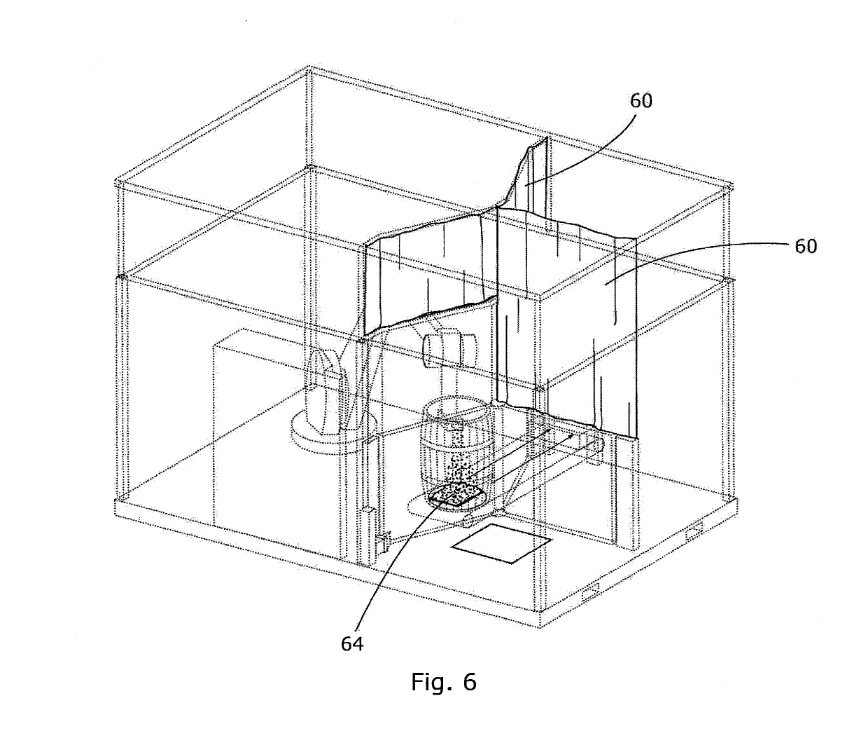

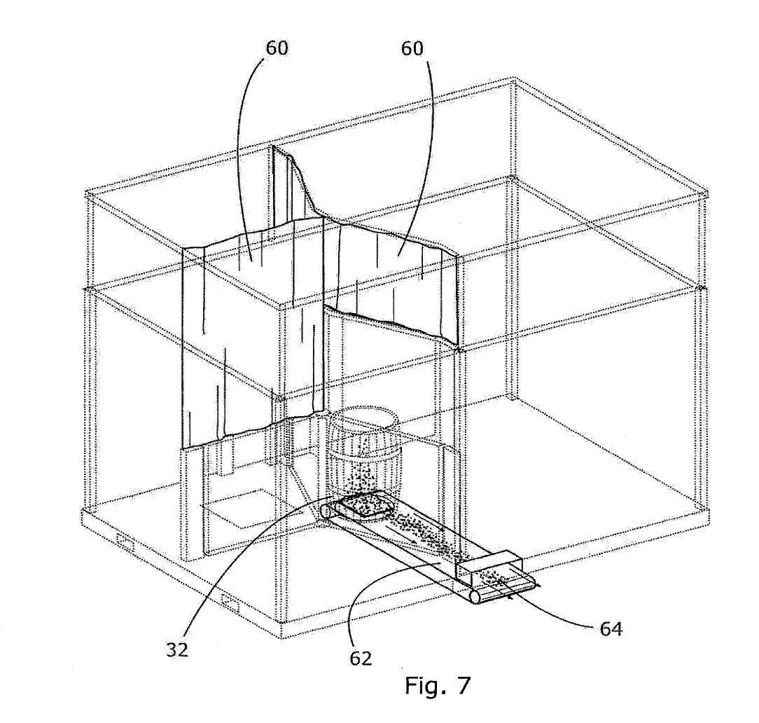

There are other features of the present invention to provide for an improved apparatus for shaving of barrels. However it is not intended that these features be essential ones of the invention. They are rather included to yet further improve the operation of the apparatus. Thus, as illustrated in FIGS. 6 and 7 curtains 60 are provided to close the gap between the turnstile walls 44, 46 and 48 and the roof 16. These curtains are provided to isolate the sections from each other so as to prevent noise and/or dust from moving around the apparatus. In addition located in section 42 just below the barrel 32 is a conveyor belt 62 that is adapted to carry the shaved wood 64 from the barrel outside of the apparatus 10 where it may be collected and disposed of.

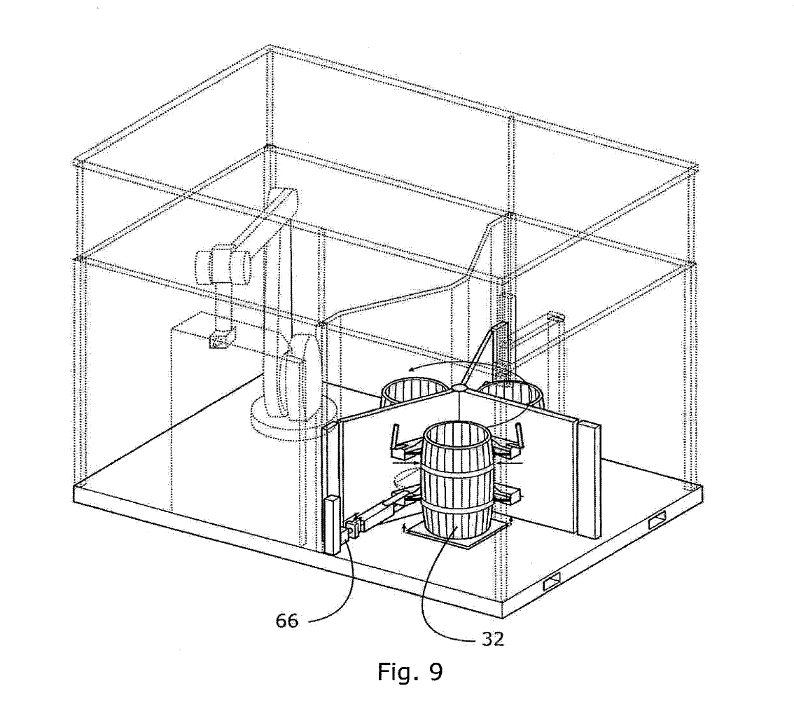

The reader would now appreciate the present invention. An apparatus is provided that provides for a facility to load a barrel, scan its internal surface and shave according to a pre-determined amount (see FIG. 9) knowing the internal surface so that a constant depth cut is achieved. Having each of the operations occur simultaneously greatly improves the efficiency as compared to other apparatus' where each operation is done sequentially on one barrel only. Of course, it may take longer to cut the surface of barrel then to scan it.

The speed of the process is therefore governed by the operation that takes the longest time. Of course in operating the apparatus certain override mechanisms must be in place such as the apparatus not being able to turn the turnstile unless a barrel has been properly fitted to the turnstile. Other safety features may include safety light curtains to ensure that if there is a person within the apparatus it shuts down.

Another feature that ensures the quality of the operation of the present apparatus is where one ensures that the turnstile is firmly locked into a position once it has rotated. One way, although not the only way, would be to have a choke 66 engage a side wall of the turnstile. The choke could be designed to be a V-shaped projection adapted to engage a correspondingly shaped cavity. This ensures that during routing the turnstile does not rotate at all ensuring that the cutting operation is very precise indeed.

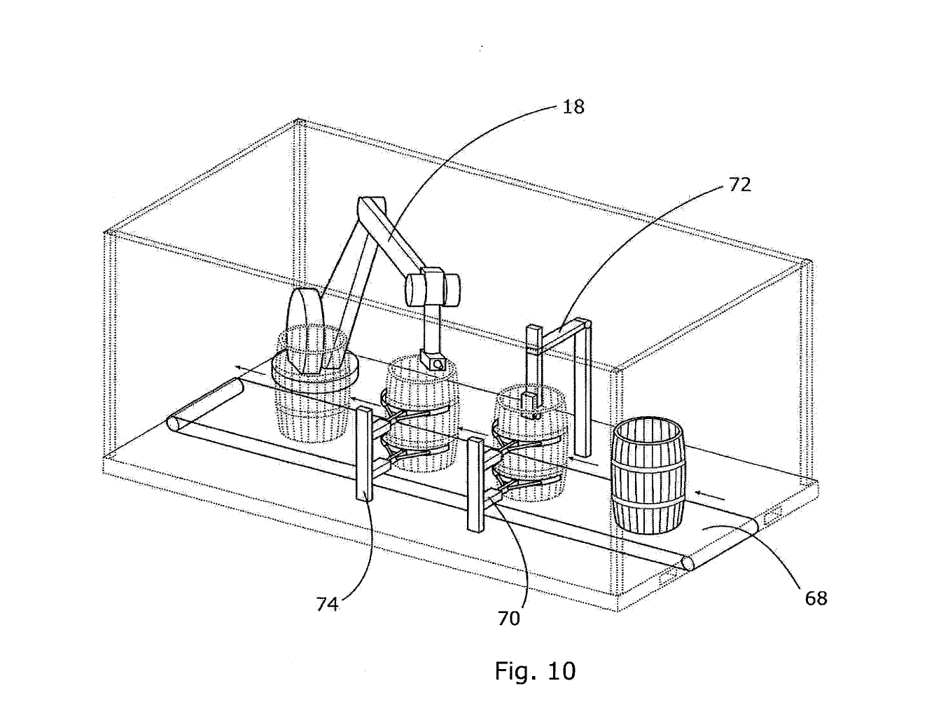

It is also to be understood that the present invention could equally well be constructed in a linear fashion such as that illustrated in FIG. 10. There a conveyor belt 68 is driven by accurate motors (not shown) until it reaches a first station where the barrel is locked into place by clamps 70 and the inside surface is scanned via scanning assembly 72. Once scanned it is then moved to the next station where it is again clamped into position by clamps 74 and then routed using robotic arm 18.

It is to be understood that the use of the term lock is not intended to mean locked as in using a key system—it is to be understood that it means that the barrel is held securely in place so that it does not move relative to the turnstile as it is being moved through the sections. The position of the barrel has to remain fixed so that once scanned the router causes the data to cut the inner surface of the barrel to a constant depth regardless of the irregularities of the inner surface.

Although not illustrated, the invention could further be adapted to provide a scanning system that scans the outside of the barrel. In this way, the absolute thickness of the barrel staves could be measured and that information used to determine a safe depth for a barrel to be cut. In this way it may even be possible for a barrel to be cut several times provide that the thickness of the staves is sufficient. The scanning could be done by the same scanning assembly that maps the internal dimensions of the barrel with the scanning arm simply moved outside of the barrel. Of course this would require the barrel to be held in position by an alternate means perhaps by engaging the ends or the inner surface of the barrel.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

Any discussion of the prior art throughout the specification should in no way be considered as an admission that such prior art is widely known or forms part of the common general knowledge in this field.

In any claims that follow and in the summary of the invention, except where the context requires otherwise due to express language or necessary implication, the word “comprising” is used in the sense of “including”, i.e. the features specified may be associated with further features in various embodiments of the invention.

1. An apparatus for reconditioning barrels, said apparatus including:
a means to lockingly engage a barrel in a first position;
a moving means to move the locked barrel into a second position;
a means to scan the internal surface of the locked barrel when in the second position and collect data;
the moving means adapted to move the locked barrel to a third position; and
a means to cut a selected depth of the internal surface of the locked barrel when in the third position.

2. An apparatus as in claim 1 wherein the selected depth cut is constant across the inner surface by using the collected data.

3. An apparatus as in claim 1 wherein the moving means is a turnstile having three sections adapted to rotate around a central axis, each of the sections including the means to lock the barrel.

4. An apparatus as in claim 1 wherein the scanning means is adapted to vertically traverse the inside surface of the barrel to thereby scan a portion thereof with each pass.

5. An apparatus as in claim 1 wherein the cutting means is adapted to vertically traverse the inside surface of the barrel to thereby shave a portion thereof with each pass.

6. An apparatus as in claim 1 wherein the cutting means is adapted to traverse the inside surface of the barrel in a continuous helical type arrangement.

7. An apparatus as in claim 1 further including a conveyor belt positioned below the barrel being shaved to remove shave wood from the apparatus.

8. A method of reconditioning a barrel including the steps of:
(a) loading and securing the barrel into a turnstile in a first position;
(b) rotating the loaded barrel to a second position;
(c) scanning the inner surface of the barrel at discrete positions and forming a database of said surface;
(d) rotating the barrel to a third position;
(e) routing the inner surface of the barrel according to the scanned inner surface to produce a constant depth of routing;
(f) rotating the barrel to the first position and unloading the barrel.

9. A method of reconditioning the barrel as in claim 8 where the turnstile includes three sections, a barrel able to be supported in each section so that barrels are being simultaneously loaded, scanned, routed and unloaded.
